(19) United States
(12) Patent Application Publication
(10) Pub. No.: US 2005/0174616 A1
(43) Pub. Date: Aug. 11, 2005

(54) Print media feeding apparatus and method thereof

(75) Inventors: Yi-Sung Chen, Taipei (TW); William Leu, Taipei (TW)

Correspondence Address: QUINTERO LAW OFFICE, 1617 BROADWAY, 3RD FLOOR, SANTA MONICA, CA, 90404, US

(73) Assignee: BENQ CORPORATION, TAOYUAN (TW)

(21) Appl. No.: 11/037,838

(22) Filed: Jan. 18, 2005

(30) Foreign Application Priority Data
Feb. 5, 2004 (TW) TW93102592

(51) Int. Cl. H04N 1/12; B65H 5/06

(52) U.S. Cl. 358/498; 271/275; 271/69; 271/198

(57) ABSTRACT

A print media feeding apparatus and method thereof. The print media feeding apparatus includes a tray, a first feeding device and a second feeding device. A print media sheet is supported by the tray. In the first feeding device, a first main roller rotates a first sub roller and a first drive belt in the same direction. In the second feeding device, a second main roller rotates a second sub roller opposite to the first main roller. When the first main roller rotates in a first direction, the first drive belt contacts and feeds the print media sheet on the tray. When the first main roller rotates in a second direction, the first drive belt moves away from the tray, and the second sub roller moves to an in-contact position and contacts and feeds the print media sheet.

### BACKGROUND OF THE INVENTION

1. Field of the Invention

The present invention relates to a feeding apparatus and method thereof, and particularly to a print media feeding apparatus for a business machine, such as a scanner.

2. Description of the Related Art

In recent years, a variety of different business machines are widely used, such as scanners, printers, fax machines and copiers. Typically, performance is affected by the speed with which the paper sheets are input and separated.

In the aforementioned machine, stacked print media sheets are individually transported by the print media feeding apparatus thereof. The print media sheets may be paper sheets, transparencies, film or envelopes. Generally, the print media sheets are stacked in place on the business machine. The print media feeding apparatus feeds the top sheet from the stack into the business machine, and the business machine executes its function.

In a first method of print media feeding, the print media feeding apparatus in, for example, a scanner, feeds, for example, a paper sheet to a scanning position. The scanning module executes a scanning process on the paper sheet, after which the print media feeding apparatus moves the paper sheet from the scanning position and out of the scanner.

In the above-mentioned method, only the print media feeding apparatus or scanning module is operated at any time. That is, the print media feeding apparatus does not feed a paper sheet while scanning is underway. Accordingly, the feeding operation does not affect the scanning process and scan quality is enhanced consistently. The discrete feeding and scanning operations do, however, increase total scanning time and reduce efficiency of the process.

In order to reduce the total scanning time, a second method of print media feeding introduces synchronized scanning and feeding operations. When the scanner receives a scanning order, the scanning module moves to a standby position while, simultaneously, the print media feeding apparatus starts to feed the paper sheet to the scanning position. When a leading edge of the paper sheet reaches the scanning position, the scanning module commences scanning, and the print media feeding apparatus continues to feed the paper sheet. The scan rate is controlled by the feed speed of the print media feeding apparatus. When scanning is complete, the paper sheet is moved from the scanning position.

In the above-mentioned method, the print media feeding apparatus and the scanning module are operated simultaneously. That is, the print media feeding apparatus continuously feeds paper sheets while the scanning is performed. It goes without saying that the total scanning time is reduced. However, since both the scanning module and the print media feeding apparatus are involved in the scanning process, impact or vibration in the feeding operation may delay or even suspend the scan rate controlled by the feed speed, with the resulting scanned image quality affected.

Generally, in the feeding operation, the impact or vibration occurs during the interchange of the feeding devices. Specifically, the print media feeding apparatus has an input feeding device to supply the paper sheet to the scanning position and an output feeding device to remove it therefrom. Impact can occur when the input feeding device passes the paper sheet to the output feeding device.

### SUMMARY OF THE INVENTION

Accordingly, an object of the present invention is to provide a print media feeding apparatus and a method thereof to provide smoother and more consistent feeding operation.

Another object of the present invention is to provide a scanner utilizing the print media feeding apparatus. Thus, with synchronized feeding and scanning, scan is consistently performed with no increase in the total scanning time.

The present invention discloses a print media feeding apparatus for guiding and feeding a print media sheet. The apparatus has a tray, a first feeding device and a second feeding device. The tray has a first end and a second opposite end, and the print media sheet is supported by the tray. The first feeding device is disposed at the first end for feeding the print media sheet toward the second end, and the second feeding device is disposed at the second end. The first feeding device has a first main roller, a first sub roller, and a first drive belt around the first main roller and the first sub roller, by which the first main roller drives the first sub roller to rotate in a same direction. The second feeding device has a second main roller and a second sub roller, and the second main roller rotates the second sub roller in an opposite direction to the first main roller.

According to the print media feeding apparatus, when the first main roller rotates in a first direction, the first sub roller moves toward a first position, the first drive belt contacts and feeds the print media sheet on the tray, and the second sub roller moves toward an out-of-contact position away from the tray. Further, when the first main roller rotates in a second rotating direction opposite to the first rotating direction, the first sub roller moves toward a second position, the first drive belt moves away from the tray, and the second sub roller moves toward an in-contact position, contacting and feeding the print media sheet on the tray.

Further, the present invention discloses a method of print media feeding. The disclosed print media feeding apparatus, is provided, and a print media sheet is provided to the tray from the first end. Then, the first main roller rotates in a first direction so that the first sub roller moves to a first position, the first drive belt contacts and feeds print media sheets on the tray, and the second sub roller moves to an out-of-contact position away from the tray. When a leading edge of the print media sheet reaches the second end, the first main roller rotates in a second direction opposite to the first direction, so that the first sub roller moves to a second position, the first drive belt moves away from the tray, and the second sub roller moves to an in-contact position and contacts and feeds the print media sheets on the tray.

The print media feeding apparatus and the method of the present invention can be applied to a scanner, in which a scanning module of the scanner is disposed under the tray for scanning the print media sheet on the tray. Further, when the first main roller rotates in the first direction in the scanner, the first drive belt contacts the print media sheet on the tray with a contact length longer than an effective optical length of the scanning module.

Preferably, in the present invention, a feed plate and a feed roller are provided. The feed plate is connected to the first end of the tray supporting the print media sheet before feeding to the tray, and the feed roller is movably disposed on the feed plate. When the feed roller is in contact with the print media sheet on the feed plate, it rotates in the first direction to feed the print media sheet on the feed plate to the tray. When the leading edge of the print media sheet reaches the first end of the tray, the first main roller rotates in the first direction and the feed roller moves away from the print media sheet. It is preferable that the second main roller rotate in same direction as the first main roller, and the feed roller rotates opposite to the first main roller.

Further, the first main roller can drive the first sub roller by the first drive belt, and the second main roller drive the second sub roller with an intermediate gear set.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic view of an embodiment of a print media feeding apparatus of the present invention;

FIG. 2A is a side view of the first feeding device 20 in FIG. 1;

FIG. 2B is a perspective view of the first feeding device 20 in FIG. 1;

FIG. 3A is a side view of the second feeding device 30 in FIG. 1;

FIG. 3B is a perspective view of the second feeding device 30 in FIG. 1;

FIG. 4 is a schematic view of the print media feeding apparatus in FIG. 1, in which the first main roller 22 rotates clockwise; and

FIG. 5 is a schematic view of the print media feeding apparatus in FIG. 1, in which the first main roller 22 rotates counterclockwise.

### DETAILED DESCRIPTION OF THE INVENTION

The present invention discloses a print media feeding apparatus and a method thereof, which can be used in a scanner or other business machine. The present invention provides an improved print media feeding apparatus to provide smoother and more consistent feeding operation. Further, with synchronized scanning and feeding, scan is consistently performed with no increase in the total scanning time.

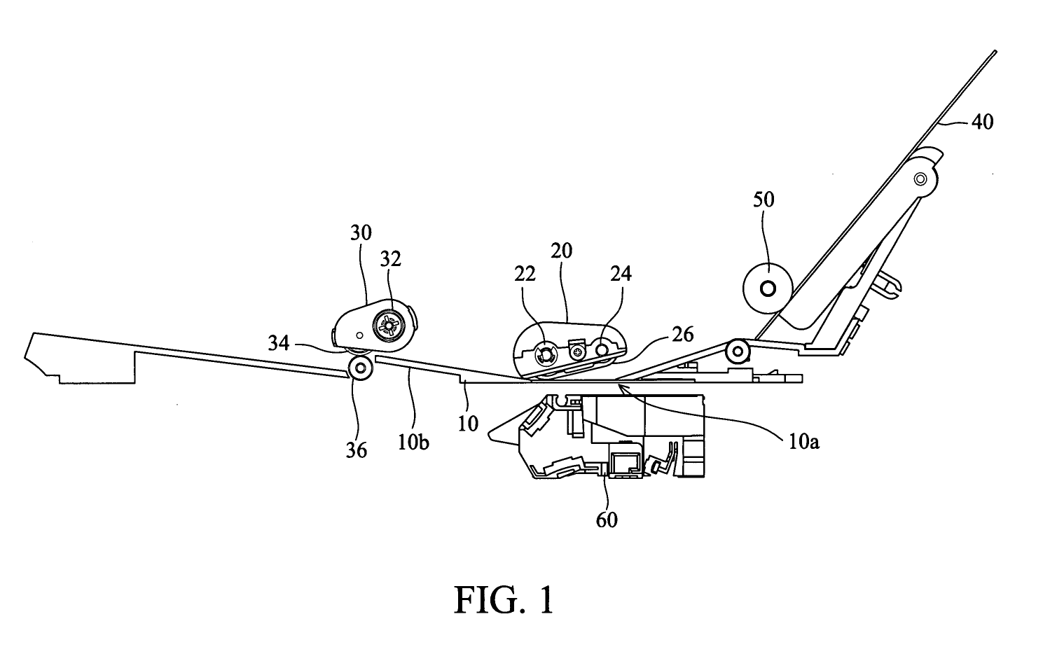

The print media feeding apparatus of the present invention guides and feeds print media. A print media sheet can be paper, a transparency, film or an envelope. An embodiment of the present invention is hereinafter described in detail with reference to FIG. 1.

FIG. 1 shows an embodiment of the print media feeding apparatus in a scanner. The print media feeding apparatus has a tray 10, a first feeding device 20, a second feeding device 30, a feed plate 40, and a feed roller 50. Further, a scanning module 60 of the scanner is disposed under the tray 10 for scanning the print media sheet on the tray 10.

As shown in FIG. 1, the tray 10 has a first end (i.e. the input end) 10a and a second end (i.e. the output end) 10b opposite the first end 10a. The print media sheet in the print media feeding apparatus is supported by the tray 10. The first feeding device 20 is disposed at the first end 10a of the tray 10 as an input feeding device, feeding the print media sheet to the second end 10b. The second feeding device 30 is disposed at the second end 10b of the tray 10 as an output feeding device. The feed plate 40 is connected to the first end 10a of the tray 10, supporting the print media sheet, before feeding to the tray 10, and the feed roller 50 is movably disposed on the feed plate 40. When the feed roller 50 is in contact with the print media sheet on the feed plate 40, the feed roller 50 rotates in a first direction (clockwise in FIG. 1) to feed the print media sheet on the feed plate 40 to the tray 10.

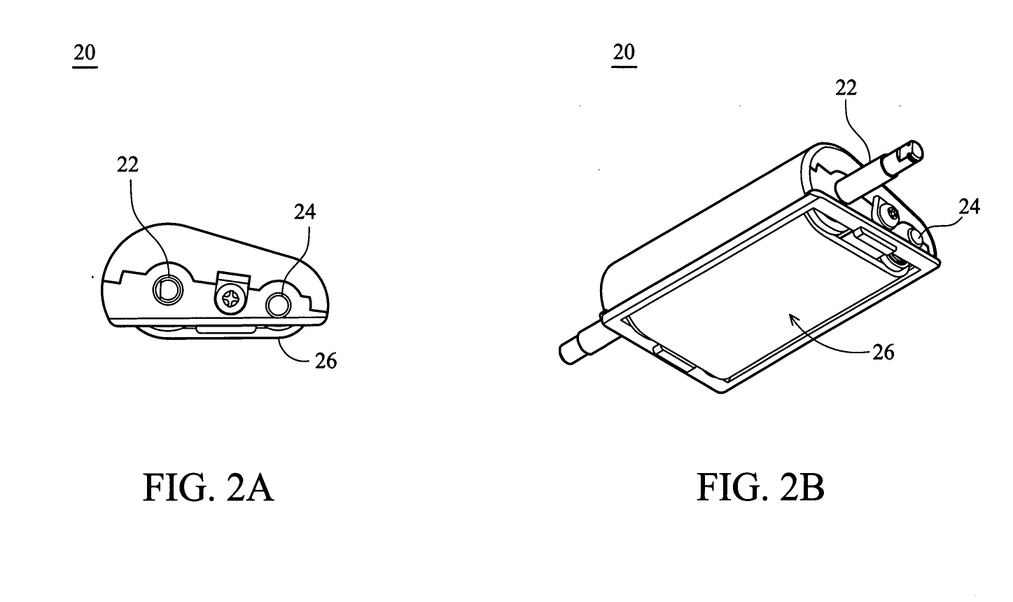

The first feeding device 20 in FIG. 1 is described with reference to FIG. 2A and FIG. 2B. The first feeding device 20 has a first main roller 22, a first sub roller 24, and a first drive belt 26 around the first main roller 22 and the first sub roller 24. The first main roller 22 is an active roller of the first feeding device 20, which can be connected to a motor (not shown) to rotate the first sub roller 24 and the first drive belt 26 in the same direction. Specifically, the first main roller 22 in the embodiment drives the first sub roller 24 by transmission of friction between the rollers 22, 24 and the first drive belt 26.

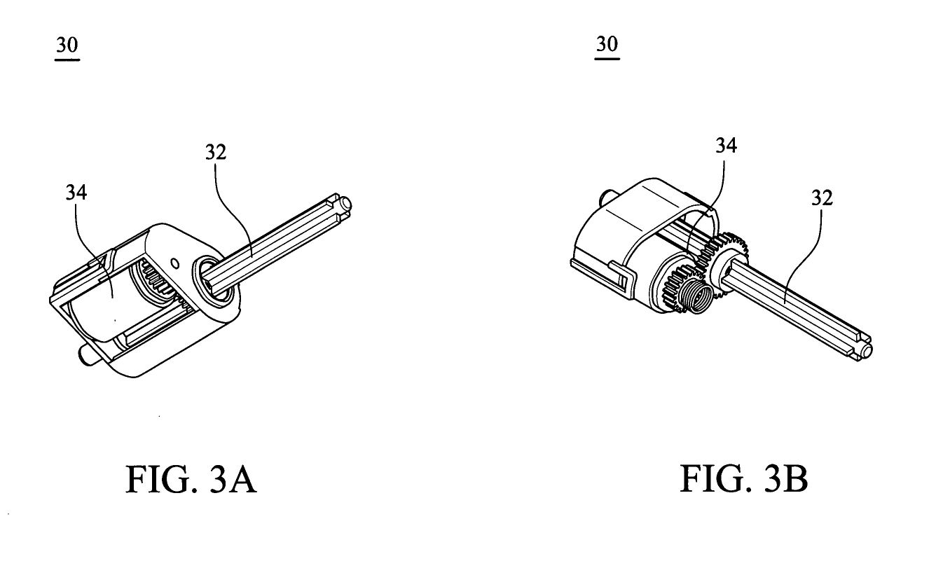

Further, the second feeding device 30 in FIG. 1 is described with reference to FIG. 3A and FIG. 3B. The second feeding device 30 has a second main roller 32 and a second sub roller 34. The second main roller 32 is an active roller of the second feeding device 30 rotating the second sub roller 34. It should be mentioned that the second sub roller 34 rotates opposite to the first main roller 22. Specifically, the second main roller 32 drives the second sub roller 34 with an intermediate gear set in FIG. 3A and FIG. 3B. Further, a idle wheel roller 36 is positioned under the second sub roller 34 to provide smooth rotation and reduce impact.

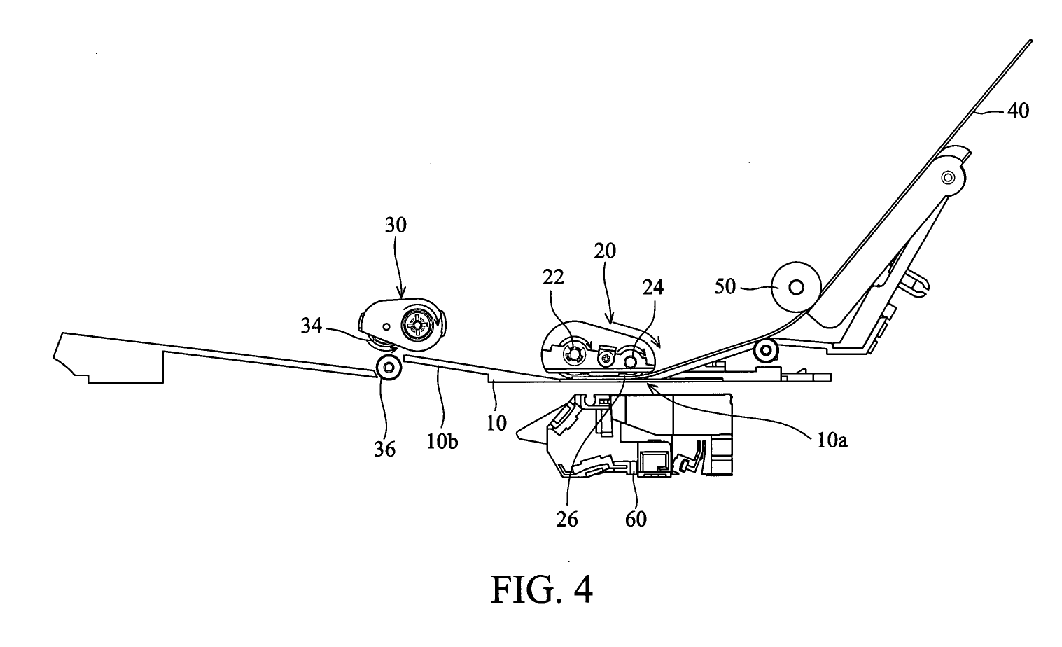

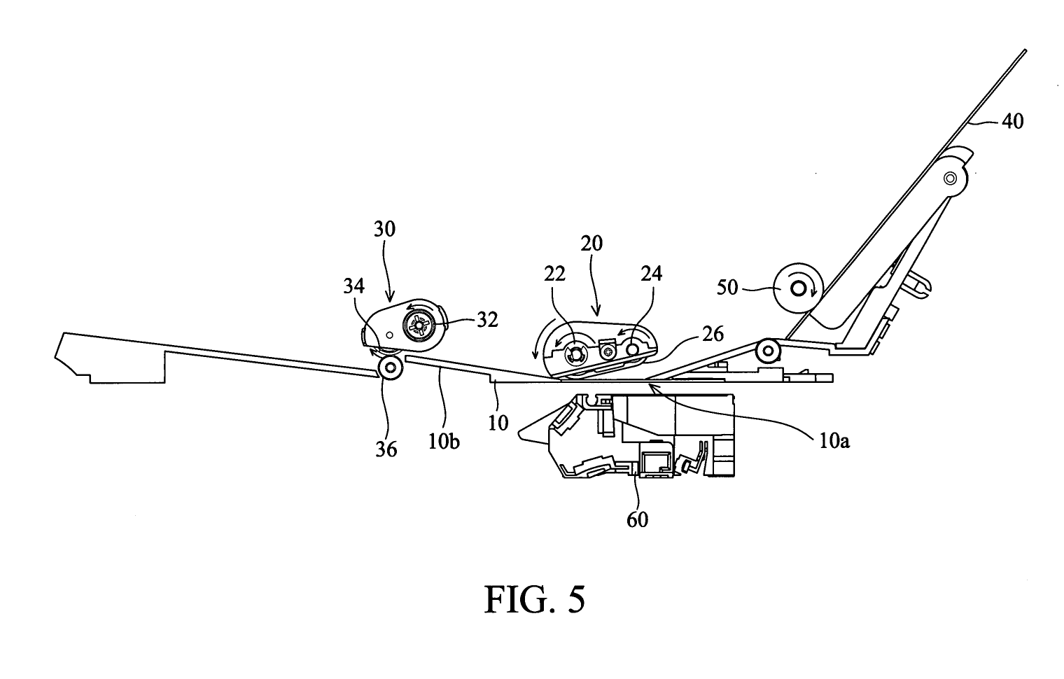

Operation of the print media feeding apparatus is described with reference to FIG. 4 and FIG. 5. In order to distinguish the distinct rotations of the rollers in the apparatus, the two opposite rotating directions are described in terms of a “first direction” and a “second direction.” In FIG. 4 and FIG. 5, the first direction is shown as clockwise, and the second direction as counterclockwise.

As shown in FIG. 4, when the first main roller 22 rotates clockwise (i.e. in the first direction), the first sub roller 24 and the first drive belt 26 are rotated clockwise. Thus a clockwise torque acts on the first sub roller 24 in relation to the first main roller 22, and the first sub roller 24: moves toward a first position as shown in FIG. 4, and the first drive belt 26 and the print media sheet on the tray 10 make surface contact. Thus, the first drive belt 26 feeds the print media sheet to the second end 10b of the tray 10 by friction. Meanwhile, the second sub roller 34, which rotates opposite to the first main roller 22, rotates counterclockwise, and a counterclockwise torque acts on the second sub roller 34 in relation to the second main roller 32. Thus, the second sub roller 34 moves to an out-of-contact position away from the tray 10 and the idle wheel roller 36.

When the first main roller 22 rotates counterclockwise (i.e. in the second direction) as shown in FIG. 5, the first sub roller 24 and the first drive belt 26 are rotated counterclockwise. Thus, a counterclockwise torque acts on the first sub roller 24 in relation to the first main roller 22, and the first sub roller 24 moves to a second position away from the tray 10 as shown in FIG. 5, and the first drive belt 26 moves away from the tray 10. Meanwhile, the second sub roller 34, which rotates opposite to the first main roller 22, rotates clockwise, and a clockwise torque acts on the second sub roller 34 in relation to the second main roller 32. Thus, the second sub roller 34 moves to an in-contact position and contacts and feeds the print media sheet on the tray 10 and the idle wheel roller 36. Further, the feed roller 50, which rotates opposite to the first main roller 22, rotates clockwise (i.e. in the first rotating direction) to feed another print media sheet on the feed plate 40 to the tray 10.

With the operation shown in FIG. 4 and FIG. 5, the method of print media feeding of the present invention is described hereinafter in detail.

First, a print media feeding apparatus as shown in FIG. 1 is provided, and a print media sheet is provided and input to the tray 10 from the first end 10a. The inputting process is performed as shown in FIG. 5, in which the feed roller 50 rotates clockwise (i.e. in the first direction) to feed the print media sheet on the feed plate 40 toward the tray 10. At this time, the first main roller 22 rotates counterclockwise (i.e. in the second direction).

When the leading edge of the print media sheet reaches the first end 10a, the feed roller 50 moves away from the print media sheet, and rotation of the first main roller 22 reverses so that the first main roller 22 rotates clockwise as shown in FIG. 4. Thus, the first sub roller 24 moves to the first position, and the first drive belt 26 contacts and feeds the print media sheet to the second end 10b of the tray 10. Meanwhile, the second sub roller 34 rotates counterclockwise and moves to an out-of-contact position away from the tray 10 and the idle wheel roller 36.

When the leading edge of the print media sheet reaches the second end 10b, rotation of the first main roller 22 reverses again so that the first main roller 22 rotates counterclockwise as shown in FIG. 5. Thus, the first sub roller 24 moves to a second position, and the first drive belt 26 moves away from the tray 10. Meanwhile, the second sub roller 34 rotates clockwise and moves to an in-contact position to contact and feed the print media sheet on the tray 10 and the idle wheel roller 36.

It should be mentioned that in the above-mentioned embodiment, the first main roller 22 drives the first sub roller 24 by the first drive belt 26, and the second main roller 32 drives the second sub roller 34 with an intermediate gear set. However, configurations other than the above-mentioned embodiment are acceptable in the present invention. For example, an additional gear set can be provided between the first main roller 22 and the first sub roller 24, or an additional drive belt can be provided between the second main roller 32 and the second sub roller 34.

Further, the scanner in the above-mentioned embodiment has the scanning module 60 disposed under the tray 10 for scanning the print media sheet on the tray.

Generally, the scanning module 60 has an effective optical length for scanning. In order to scan effectively, when the first main roller 22 rotates in the first rotating direction (as shown in FIG. 4) in the scanner, the first drive belt 26 contacts the print media sheet on the tray 10 with a contact length longer than the effective optical length of the scanning module 60.

The print media feeding apparatus and the method of the present invention can be applied to provide smoother and more consistent feeding operation.

Further, in the scanner of the present invention, scanning and feeding are simultaneously performed. Thus, with synchronized scanning and feeding, scan is consistently performed with no increase in the total scanning time.

It should be mentioned that the print media feeding apparatus and the method disclosed are applied in a scanner. However, the present invention is not limited thereto, and the print media feeding apparatus and the method can be applied in a variety of other business machines.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A print media feeding apparatus for guiding and feeding a print media sheet, the print media feeding apparatus comprising:
a tray comprising a first end and a second end opposite to the first end, the print media sheet supported by the tray;
a first feeding device disposed at the first end for feeding the print media sheet toward the second end, the first feeding device comprising a first main roller, a first sub roller, and a first drive belt around the first main roller and the first sub roller, the first main roller rotating the first sub roller and the first drive belt in the same direction; and
a second feeding device disposed at the second end, comprising a second main roller and a second sub roller, the second main roller rotating the second sub roller opposite to the first main roller;
when the first main roller rotates in a first direction, the first sub roller moves to a first position, the first drive belt contacts and feeds the print media sheet on the tray, and the second sub roller moves to an out-of-contact position away: from the tray; and
when the first main roller rotates in a second direction opposite to the first direction, the first sub roller moves to a second position, the first drive belt moves away from the tray, and the second sub roller moves to an in-contact position and contacts and feeds the print media sheet on the tray.

2. The print media feeding apparatus as claimed in claim 1, wherein the second main roller rotates in the same direction as the first main roller.

3. The print media feeding apparatus as claimed in claim 1, further comprising:
a feed plate connected to the first end of the tray supporting the print media sheet before feeding to the tray; and
a feed roller movably disposed on the feed plate, rotating in the first direction to feed the print media sheet on the feed plate to the tray when the feed roller contacts the print media sheet.

4. The print media feeding apparatus as claimed in claim 3, wherein the second main roller rotates in the same direction as the first main roller, and the feed roller rotates opposite to the first main roller.

5. The print media feeding apparatus as claimed in claim 3, wherein the first main roller, rotates in the first rotating direction and the feed roller moves away from the print media sheet when a leading edge of the print media sheet reaches the first end of the tray.

6. The print media feeding apparatus as claimed in claim 1, wherein the first main roller rotates the first sub roller by the first drive belt.

7. The print media feeding apparatus as claimed in claim 1, wherein the second main roller rotates the second sub roller by an intermediate-gear set.

8. A method of print media feeding, comprising the steps of:
providing a tray having a first end and a second end opposite to the first end;
providing a first feeding device at the first end, comprising a first main roller, a first sub roller, and a first drive belt around the first main roller and the first sub roller, the first main roller rotating the first sub roller and the first drive belt in the same direction;
providing a second feeding device at the second end, comprising a second main roller and a second sub roller, the second main roller rotating the second sub roller opposite to the first main roller;
providing a print media sheet to the tray from the first end;
rotating the first main roller in a first direction so that the first sub roller moves to a first position, the first drive belt contacts and feeds the print media sheet on the tray, and
the second sub roller moves to an out-of-contact position away from the tray; and
rotating the first main roller in a second direction opposite to the first direction when a leading edge of the print media sheet reaches the second end, so that the first sub roller moves to a second position, the first drive belt moves away from the tray, and the second sub roller moves to an in-contact position and contacts and feeds the print media sheet on the tray.

9. The method of print media feeding as claimed in claim 8, wherein the second main roller rotates in the same direction as the first main roller.

10. The method of print media feeding as claimed in claim 8, further comprising the steps of:
providing a feed plate connected to the first end of the tray supporting the print media sheet before feeding to the tray, and a feed roller movably disposed on the feed plate; and
moving the feed roller contacting the print media sheet on the feed plate and rotating the feed roller in the first direction to feed the print media sheet on the feed plate toward the tray.

11. The method of print media feeding as claimed in claim 10, wherein the feed roller moves away from the print media sheet and the first main roller rotates in the first direction when the leading edge of the print media sheet reaches the first end of the tray.

12. The method of print media feeding as claimed in claim 10, wherein the second main roller rotates in the same direction to the first main roller, and the feed roller rotates opposite to the first main roller.

13. A scanner for scanning a print media sheet, the scanner comprising:
a tray comprising a first end and a second end opposite thereto, the print media sheet supported by the tray;
a first feeding device disposed at the first end feeding the print media sheet to the second end, comprising a first main roller, a first sub roller, and a first drive belt around the first main roller and the first sub roller, the first main roller rotating the first sub roller and the first drive belt in the same direction;
a second feeding device disposed at the second end, comprising a second main roller and a second sub roller, the second main roller rotating the second sub roller opposite to the first main roller; and
a scanning module disposed under the tray scanning the print media sheet on the tray;
wherein, when the first main roller rotates in a first direction, the first sub roller moves to a first position, the first drive belt contacts the print media sheet on the tray with a contact length and feeds the print media sheet, and the second sub roller moves to an out-of-contact position away from the tray, wherein the contact length exceeds an effective optical length of the scanning module; and
when the first main roller rotates in a second direction opposite to the first direction, the first sub roller moves to a second position, the first drive belt moves away from the tray, and the second sub roller moves to an in-contact position and contacts and feeds the print media sheet on the tray.

14. The scanner as claimed in claim 13, wherein the second main roller rotates in the same direction to the first main roller.

15. The scanner as claimed in claim 13, further comprising:
a feed plate connected to the first end of the tray supporting the print media sheet before feeding to the tray; and
a feed roller movably disposed on the feed plate, rotating in the first direction to feed the print media sheet on the feed plate to the tray when the feed roller contacts the print media sheet on the feed plate.

16. The scanner as claimed in claim 15, wherein the second main roller rotates in the same direction to the first main roller, and the feed roller rotates opposite to the first main roller.

17. The scanner as claimed in claim 15, wherein the first main roller rotates in the first direction and the feed roller moves away from the print media sheet when a leading edge of the print media sheet reaches the first end of the tray.

18. The scanner as claimed in claim 13, wherein the first main roller rotates the first sub roller by the first drive belt.

19. The scanner as claimed in claim 13, wherein the second main roller rotates the second sub roller by an intermediate gear set.
